(19) United States
(12) Patent Application Publication
(10) Pub. No.: US 2006/0182239 A1
(43) Pub. Date: Aug. 17, 2006

(54) Process for synchronizing a speech service and a visual presentation

(76) Inventors: Yves Lechervy, Saint Genevieve Des Bois (FR); Hubert Fourre, Saint Michel Sur Orge (FR)

Correspondence Address: YOUNG & THOMPSON, 745 SOUTH 23RD STREET, 2ND FLOOR, ARLINGTON, VA, 22202, US

(21) Appl. No.: 11/353,986

(22) Filed: Feb. 15, 2006

(30) Foreign Application Priority Data
Feb. 16, 2005 (FR) 0501593

(51) Int. Cl. H04M 1/64

(52) U.S. Cl. 379/88.17

(57) ABSTRACT

A process for synchronizing speech information on a first terminal and a visual presentation of data on a second terminal, the first terminal managing a speech communication channel towards a speech server, the second terminal managing a data communication channel towards a contents distribution server, which includes the steps of: the transmission by the speech server to the contents distribution server of a request to send a page, the sending by the contents distribution server to the second terminal of the page, the transmission from the contents distribution server to the speech server of an indication of the end of receipt of the page, the transmission by the speech server of the speech information associated with the page to the first terminal.

### BACKGROUND OF THE INVENTION

The present invention relates to a process for synchronizing a speech service on a first terminal and a visual presentation of data in the form of pages on a second terminal. It relates also to a speech server and a contents distribution server for implementing the process.

The speech servers currently deployed enable a predefined text to be vocalised and/or enable purely speech navigation to be carried out. They are therefore machines having states which evolve as a function of the user's requests.

In addition, WAP standard (Wireless Application Protocol; standard maintained by the Open Mobile Alliance, ex Wap Forum) telephony terminals are capable of proposing conventional Internet navigation by using the keyboard or a touch screen.

This control by keyboard or touch screen can be replaced by speech commands when the language used by the navigator and the pages consulted is of the “voice XML” type or “SALT” type (Speech Application Language Tags).

Compared with a conventional WAP standard terminal, this has the disadvantage of obliging the navigator of the terminal to incorporate a new interpretation module in order to synchronize speech streams and data displays.

This problem arises in the case of any terminal on which it is desired to synchronize speech streams with data displays, and also in the case where this synchronization must be effected with a first terminal which receives the speech stream and a second terminal which displays the data.

The object of the invention is therefore to enable navigation through.pages of data to be synchronized with speech elements without modifying the terminals.

### SUMMARY OF THE INVENTION

The invention therefore relates to a process for synchronizing speech information on a first terminal and a visual presentation of data in the form of pages on a second terminal,

the first terminal managing a speech communication channel towards a speech server,

the second terminal managing a data communication channel towards a contents distribution server, which process comprises the steps of:
the transmission by the speech server to the contents distribution server of a request to send a page,
the sending by the contents distribution server to the second terminal of the page requested,
the transmission from the contents distribution server to the speech server of an indication of the end of receipt of the page,
the transmission by the speech server of the speech information associated with the page to the first terminal on receiving the indication of the end of receipt of the page.

Other features of the process are:
it comprises a transmission by the second terminal of an acknowledgement of receipt addressed to the contents distribution server before the transmission by the contents distribution server of the indication of the end of receipt of the page,
the transmission by the second terminal of an acknowledgement of receipt is effected by the second terminal's sending to the contents distribution server a request for the receipt of a predetermined element of the requested page, this request being suitable for signalling the successful receipt of the page requested by the second terminal;
in addition, before the step of sending the requested page to the second terminal, it comprises the steps of:
sending from the contents distribution server to the second terminal a message containing an address of the page to be sent as a parameter;
sending in response a request asking for the receipt of the page from the second terminal to the contents distribution server;
the sending from the contents distribution server to the second terminal of a message containing an address of the page to be sent as a parameter triggers the opening of the communication of data between the contents distribution server and the second terminal if that communication does not exist;
it also comprises a preliminary step of the transmission of a speech service request by the first terminal to the speech server; and
the first and second terminals are commoned.

The invention relates also to a speech server for implementing the process, comprising:
means for speech communication with a terminal managing a speech communication channel, and
means for data communication with a contents distribution server,
means for generating a request to send a page, which means are connected to the data communication means for the transmission of that request to the contents distribution server, and
means for transmitting a speech service addressed to the terminal, by way of the speech communication means, on receiving a transmission command received from the contents server by way of the data communication means.

A feature of this speech server is that the means for generating a send request are connected to the speech communication means and are suitable for generating the request on receiving a speech service request coming from the terminal.

The invention relates also to a contents distribution server for implementing the process, comprising:
first means for data communication with a terminal for the visual presentation of data in the form of pages, which terminal manages a data communication channel, and
second means for data communication with a speech server,
means for transmitting a page to the terminal, which means are suitable for transmitting that page on receiving a request to send the page coming from the speech server,
means for receiving an acknowledgement of receipt transmitted by the terminal in order to indicate that the page sent has been successfully received, and
means for sending a speech service distribution request to the speech server by way of the data communication means, the sending means being suitable for transmitting that request only after receiving the acknowledgment of receipt transmitted by the terminal.

The invention relates also to a software product for implementation by a computer such that this computer acts as a speech server.

The invention relates also to a software product for implementation by a computer such that this computer acts as a contents distribution server.

### BRIEF DESCRIPTION OF THE DRAWINGS

The invention will be better understood on reading the following description which is given purely by way of example and with reference to the drawings in which:

FIG. 1 is a schematic view of the elements used in a preferred embodiment of the invention;

FIG. 2 is a flow chart of the message streams of an embodiment of the process according to the invention,

FIG. 3 is a schematic view of a speech server according to a preferred embodiment of the invention, and

FIG. 4 is a schematic view of a contents distribution server according to a preferred embodiment of the invention.

### DETAILED DESCRIPTION OF THE PREFERRED EMBODIMENTS

A first embodiment using the WAP standard and a WAP terminal will now be described.

A mobile telephone conforming to the WAP standard for requesting and receiving pages coming from a Web server is called a “WAP terminal”.

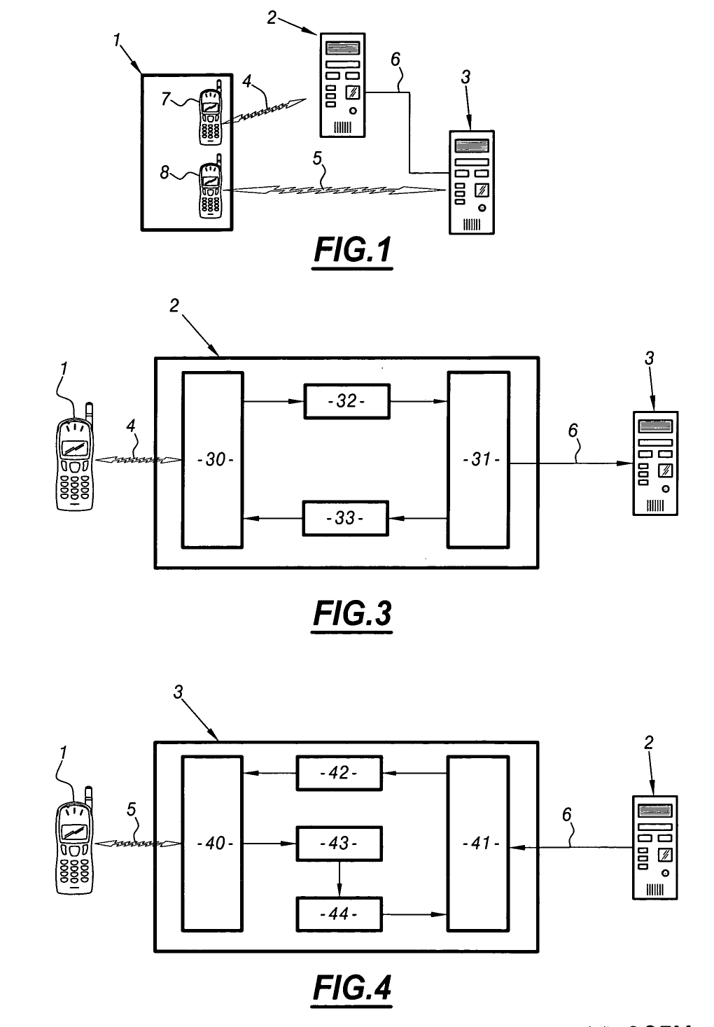

Referring to FIG. 1, a WAP standard terminal 1 is in communication with a speech server 2 and a contents distribution server 3 by radio links 4 and 5. The two servers 2, 3 are connected to each other by a conventional data link 6, for example a wire link.

The terminal 1 therefore comprises a speech-type link 4 with the speech server 2 and a data-type link 5 with the contents distribution server 3.

The speech server 2 is conventionally capable of transmitting speech messages that are prerecorded or created dynamically and of interpreting a stream of phonemes transmitted by the user of the terminal 1 as a command to be carried out.

The contents distribution server 3 is, for example, a Web server.

For clarity of description, the speech server 2 and the contents distribution server 3 are represented separately. However, in one particular embodiment, those two servers function on the same machine and the data link 6 is then effected in the form of an inter-process communication link.

Likewise, the terminal 1 is shown in the form of two terminals 7 and 8. The first terminal 7 is a speech terminal which is in relationship with the speech server 2 by way of the speech-type link 4 and the second terminal 8 is a terminal for the presentation of data in the form of pages which is in relationship with the contents distribution server 3 by way of the data link 5. Thus, it is shown symbolically that it is superfluous to provide a link between the speech portion and the data presentation portion.

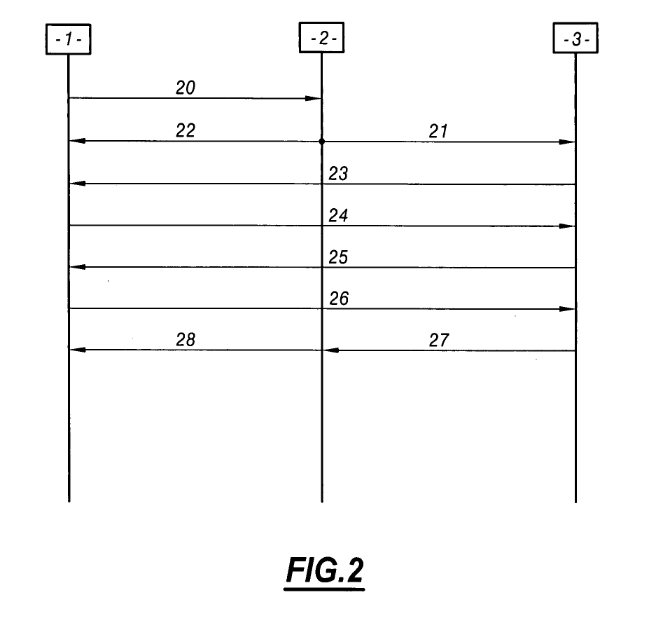

An embodiment of the process will now be described in relation to FIG. 2. In a conventional manner, each element (the terminal 1, the speech server 2, the contents distribution server 3) is represented by a solid vertical line. The data transfers are represented by horizontal lines which are arrowed to indicate the direction of transfer. The temporal progress of the process is read from the top to the bottom of the Figure.

At step 20, the terminal 1 transmits a service-opening call in the direction towards the speech server 2.

At step 21, the speech server 2, in response to the service-opening call, transmits in the direction towards the contents distribution server 3 a request to send a page corresponding to the service requested.

Optionally, and in parallel, the speech server 2 transmits at 22 in the direction towards the terminal 1 a welcome message.

The contents distribution server 3 cannot send the requested page directly because the WAP standard, like the HTTP standard, requires that a page should be sent to a navigator only at the navigator's request (“pull” mode) The contents distribution server 3 therefore transmits at 23, in the direction towards the terminal 1, a “WAP Push SL” message containing as a parameter the URL (Uniform Resource Locator) for access to the page to be sent.

This “WAP Push SL” message has formed part of the WAP standard since version 1.2.1 thereof. This message is transmitted by a server in the direction towards a terminal so that the latter immediately downloads content whose address is a parameter of the message and presents it directly to the user without interaction of the latter.

On receiving this “WAP Push SL” message, the terminal 1 transmits at 24 a request asking for the receipt of the page whose address is in the form of a parameter of the “WAP Push SL” message. Conventionally, this request is based on the GET command of the HTTP protocol.

The contents distribution server 3 sends in return, step 25, the requested page.

This page comprises a predetermined element in the form, for example, of an image, whose downloading address is found on the contents distribution server 3. This predetermined element is positioned at the end of the file of the requested page, for example, just before the closing tag </body> in wml.

Thus, the request asking for the receipt of the predetermined element is carried out, step 26, when the terminal has received all of the elements of the requested page.

On receiving that request from the terminal 1, the contents distribution server 3 transmits at 27 a command for the transmission of the speech service by the speech server 2.

On receiving that command, the speech server 2 transmits at 28 the speech service addressed to the terminal 1.

Thus, the speech service is advantageously synchronized with the display of the visual contents.

As will have been appreciated on reading the above description, this synchronization between speech and display is possible without modifying the terminal 1, the latter being simply in conformity with the WAP standard and capable of having two communication channels open at the same time, one for speech and the other for data, in other words, it is a bi-modal WAP terminal.

In general, the process thus described may also be implemented with technologies other than WAP technology, such as, for example, “i-mode” technology when this technology offers the possibility of sending a page of data to the terminal on the initiative of the contents distribution server.

Likewise, the terminal 1 can be broken down into a first terminal 7 managing the channel 4 for speech communication with the speech server 2 and a second terminal 8 managing the channel 5 for data communication with the contents distribution server 3.

The process is therefore composed, in a general manner, of the steps of:
the transmission by the speech server 2 to the contents distribution server 3 of a request to send a page,
the sending of the requested page by the contents distribution server 3 to the second terminal 8,
the transmission from the contents distribution server 3 to the speech server 2 of an indication of the end of receipt of the page, and
the transmission of the speech information associated with the page by the speech server 2 to the first terminal 7 on receiving the indication of the end of receipt of the page.

With regard to the speech server 2, FIG. 3, it comprises conventional means 30 for speech communication with the terminal 1 in the form of a speech link, and also conventional means 31 for data communication with the contents distribution server 3.

The speech server 2 also comprises means 32 for generating a request to send a page, this request being transmitted in the direction towards the contents distribution server 3 during step 21 of FIG. 2. The generation means 32 are connected to the speech communication means 30 in such a manner as to generate the request during the receipt of the service request coming from the terminal 1.

The speech server 2 also comprises means 33 for transmitting the speech service addressed to the terminal 1 by way of the speech communication means 30. This transmission is triggered on receiving a transmission command received from the contents distribution server 3 by way of the data communication means 31.

The contents distribution server 3 comprises first data communication means 40 suitable for establishing a data link with the terminal 1 and second data communication means 41 for establishing a data link with the speech server 2.

The contents distribution server 3 also comprises means 42 for transmitting a page to the terminal 1. These transmission means 42 are connected to the second data communication means 41 in such a manner as to transmit the page only on receiving the request to send a page coming from the speech server 2.

The contents distribution server 3 also comprises means 43 for receiving an acknowledgement of receipt transmitted by the terminal 1 in order to indicate that the page sent has been successfully received. One particular embodiment consists, as indicated above, in causing the terminal 1 to transmit a request to a predetermined element when the page has been completely received.

The contents distribution server 3 also comprises means 44 for sending a request for the distribution of the speech service. This request is sent to the speech server 2 by way of the communication means 41. These sending means 44 are suitable for transmitting that request only after receiving the acknowledgement of receipt transmitted by the terminal

The process, the speech server and the contents distribution server 3 thus described are capable of being implemented in detail in numerous manners.

For example, the management of the “WAP Push SL” messages can be delegated to an autonomous server. In that case, the contents distribution server 3 remains a conventional server responding to HTTP requests.

Likewise, it will be appreciated that the speech server 2 and the contents distribution server 3 can be implemented by software using standard computers.

The process described therefore advantageously enables a speech service to be synchronized with displayable data without the need to modify the terminal.

1. A process for synchronizing speech information on a first terminal and a visual presentation of data in the form of pages on a second terminal,
the first terminal managing a speech communication channel towards a speech server,
the second terminal managing a data communication channel towards a contents distribution server, characterized in that it comprises the steps of:
the transmission by the speech server to the contents distribution server of a request to send a page,
the sending by the contents distribution server to the second terminal of the page requested,
the transmission from the contents distribution server to the speech server of an indication of the end of receipt of the page,
the transmission by the speech server of the speech information associated with the page to the first terminal on receiving the indication of the end of receipt of the page.

2. A synchronization process according to claim 1, characterized in that it comprises a transmission by the second terminal of an acknowledgement of receipt addressed to the contents distribution server before the transmission by the contents distribution server of the indication of the end of receipt of the page.

3. A process according to claim 2, characterized in that the transmission by the second terminal of an acknowledgement of receipt is effected by the second terminal's sending to the contents distribution server a request for the receipt of a predetermined element of the requested page, this request being suitable for signalling the successful receipt of the page requested by the second terminal.

4. A process according to claim 1, characterized in that, in addition, before the step of sending the requested page to the second terminal, it comprises the steps of:
sending from the contents distribution server to the second terminal a message containing an address of the page to be sent as a parameter,
sending in response a request asking for the receipt of the page from the second terminal to the contents distribution server.

5. A process according to claim 4, characterized in that the sending from the contents distribution server to the second terminal of a message containing an address of the page to be sent as a parameter triggers the opening of the communication of data between the contents distribution server and the second terminal if that communication does not exist.

6. A process according to claim 1, characterized in that it also comprises a preliminary step of the transmission of a speech service request by the first terminal to the speech server.

7. A process according to claim 1, characterized in that the first and second terminals are commoned.

8. A speech server for implementing the process according to claim 1, characterized in that it comprises:
means for speech communication with a terminal managing a speech communication channel, and
means for data communication with a contents distribution server,
means for generating a request to send a page, which means are connected to the data communication means for the transmission of that request to the contents distribution server, and
means for transmitting a speech service addressed to the terminal, by way of the speech communication means, on receiving a transmission command received from the contents server by way of the data communication means.

9. A speech server according to claim 8, characterized in that the means for generating a send request are connected to the speech communication means and are suitable for generating the request on receiving a speech service request coming from the terminal.

10. A contents distribution server for implementing the process according to claim 1, characterized in that it comprises:
first means for data communication with a terminal for the visual presentation of data in the form of pages, which terminal manages a data communication channel, and
second means for data communication with a speech server,
means for transmitting a page to the terminal, which means are suitable for transmitting that page on receiving a request to send the page coming from the speech server,
means for receiving an acknowledgement of receipt transmitted by the terminal in order to indicate that the page sent has been successfully received, and
means for sending a speech service distribution request to the speech server by way of the data communication means, the sending means being suitable for transmitting that request only after receiving the acknowledgment of receipt transmitted by the terminal.

11. A software product for implementation by a computer such that this computer acts as a speech server according to claim 8.

12. A software product for implementation by a computer such that this computer acts as a contents distribution server according to claim 10.
